(19) United States
(12) Patent Application Publication
(10) Pub. No.: US 2021/0264484 A1
(43) Pub. Date: Aug. 26, 2021

(54) PREDICTIVE PAYMENT SYSTEM AND METHOD

(71) Applicant: Wells Fargo Bank, N.A., San Francisco, CA (US)

(72) Inventors: Tony Jay Boettcher, Saint Louis Park, MN (US); Alyssa L. Demers, Plymouth, MN (US); Thomas M. Pendolino, Burlingame, CA (US); Garrett Steven Weiss, San Francisco, CA (US)

(21) Appl. No.: 15/349,669

(22) Filed: Nov. 11, 2016

(51) Int. Cl. G06Q 30/04; G06Q 20/32

(52) U.S. Cl. CPC G06Q 30/04; G06Q 20/32

(57) ABSTRACT

Embodiments of the present disclosure provide a number of advantages and improvements over conventional electronic bill payment systems. Among other things, embodiments of the disclosure may be used by parties to electronic payments (e.g., payers and payees) to identify the status of payments in real time or near-real time. A predictive model may be used to determine the success rate/average time for processing payments based on past behavior of a particular payer or group of payers. Additionally, embodiments of the disclosure may be used to help facilitate the acceleration or extension of payments based on a payee's current cash flow needs.

### TECHNICAL FIELD

Among other things, embodiments pertain to determining the likelihood a payer of a future payment will successfully provide the payment by a due date.

### BACKGROUND

As electronic bill payment systems grow in popularity to provide electronic payments over the Internet, a number of challenges with such systems have emerged. For example, many conventional electronic bill payment systems have little ability to predict if or when payments from various payers will arrive, particularly when payers can utilize a variety of financial institutions and methods of payment to satisfy debts. Embodiments of the present disclosure address these and other issues.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 illustrates a block diagram of an exemplary system according to various aspects of the disclosure;

FIG. 2 is a flow diagram of an exemplary process according to various aspects of the disclosure; and

FIG. 3 is a block diagram of an exemplary machine according to various aspects of the disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Embodiments of the present disclosure provide a number of advantages and improvements over conventional electronic bill payment systems. Among other things, embodiments of the disclosure may be used by parties to electronic payments (e.g., payers and payees) to identify the status of payments in real time or near-real time. A predictive model may be used to determine the success rate/average time for processing payments based on past behavior of a particular payer or group of payers. Additionally, embodiments of the disclosure may be used to help facilitate the acceleration or extension of payments based on a payee's current cash flow needs.

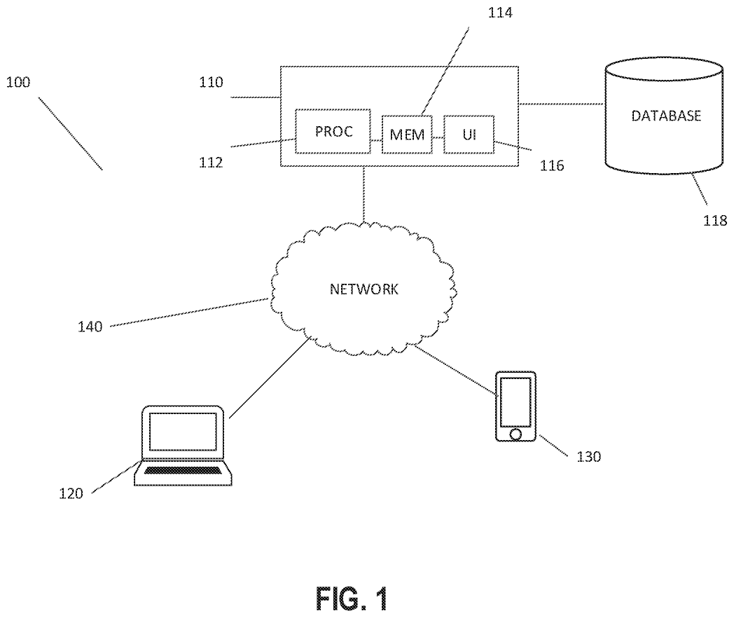

FIG. 1 is a block diagram of system which may be used in conjunction with various embodiments. While FIG. 1 illustrates various components of a computer system, it is not intended to represent any particular architecture or manner of interconnecting the components. Other systems that have fewer or more components may also be used.

In FIG. 1, the system 100 includes a server computer system 110 comprising a processor 112, memory 114, and user interface 116. Computer system 110 may include any number of different processors, memory components, and user interface components, and may interact with any other desired systems and devices in conjunction with embodiments of the present disclosure.

The functionality of the computer system 110, including the steps of the methods described below (in whole or in part), may be implemented through the processor 112 executing computer-readable instructions stored in the memory 114 of the system 110. The memory 114 may store any computer-readable instructions and data, including software applications, applets, and embedded operating code. Portions of the functionality of the methods described herein may also be performed via software operating on one or more of the client computing devices 120, 130.

The functionality of the system 110 or other system and devices operating in conjunction with embodiments of the present disclosure may also be implemented through various hardware components storing machine-readable instructions, such as application-specific integrated circuits (ASICs), field-programmable gate arrays (FPGAs) and/or complex programmable logic devices (CPLDs). Systems according to aspects of certain embodiments may operate in conjunction with any desired combination of software and/or hardware components. The processor 112 retrieves and executes instructions stored in the memory 114 to control the operation of the system 110. Any type of processor, such as an integrated circuit microprocessor, microcontroller, and/or digital signal processor (DSP), may be used in conjunction with embodiments of the present disclosure. A memory 114 operating in conjunction with embodiments of the disclosure may include any combination of different memory storage devices, such as hard drives, random access memory (RAM), read only memory (ROM), FLASH memory, or any other type of volatile and/or nonvolatile memory. Data may be stored in the memory 114 in any desired manner, such as in a relational database.

The system 110 includes a user interface 116 that may include any number of input devices (not shown) to receive commands, data, and other suitable input. The user interface 116 may also include any number of output devices (not shown) to provides the user with data, notifications, and other information. Typical I/O devices may include mice, keyboards, modems, network interfaces, printers, scanners, video cameras and other devices.

The system 110 may communicate with one or more client computing devices 120, 130 as well as other systems and devices in any desired manner, including via network 140. The system 110 and/or computing devices 120 may be, include, or operate in conjunction with, a laptop computer, a desktop computer, a mobile subscriber communication device, a mobile phone, a personal digital assistant (PDA), a tablet computer, an electronic book or book reader, a digital camera, a video camera, a video game console, and/or any other suitable computing device. In one exemplary embodiment, described in more detail below, client computing device 120 is operated by a payee of an amount owed while client computing device 130 is operated by a payer of the amount owed. Embodiments of the present disclosure may operate in conjunction with any number of different payer and/or payee computing devices.

The network 140 may include any electronic communications system or method. Communication among components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of existing or future protocols.

The system 110 may include (e.g., in the memory 114) a database, and may communicate with any number of other databases, such as database 118. Any such databases may include a relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically.

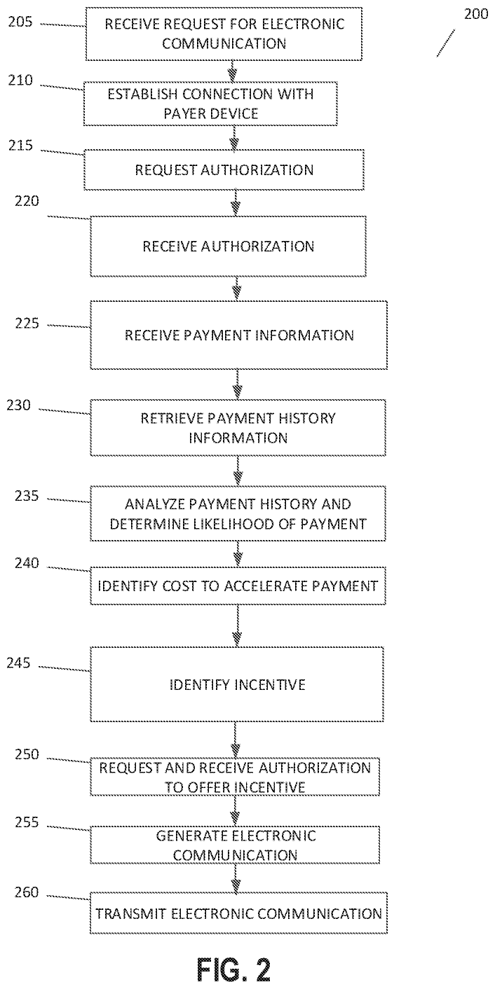

FIG. 2 depicts an exemplary process according to various aspects of the present disclosure. In this example, method 200 includes receiving a request for an electronic communication containing information about a payment from a payer (205), establishing a connection with a computing device of a payer (210), requesting (215) and receiving (220) authorization from the payer to control functionality on the payer's device, and receiving (225) payment information. Method 200 further includes retrieving payment history information for the payer (230) and analyzing the payment history information to determine a likelihood of payment (235). Method 200 additionally includes identifying the costs/benefits to a payee to accelerate the payment (240), identifying an incentive to offer the payer for accelerating the payment (245), requesting and receiving authorization from the payee to offer the incentive to the payer (250), and generating (255) and transmitting (260) an electronic communication to a computing device of the payer. The steps of method 200 may be performed in whole or in part, may be performed in conjunction with some or all of the steps in other methods, and may be performed by any number of different systems, such as the systems described in FIGS. 1 and/or 3.

Embodiments of the present disclosure may be used to help parties to electronic payment transactions (e.g., payers and payees) and others monitor the status of, and alter the terms of, such transactions. For example, in the system 100 shown in FIG. 1, a server computer system 110 communicates with a computing device of a payee 120 (i.e., an entity to whom a payment is owed) and computing device of a payer 130 (i.e., an entity from whom the payment is owed). The payee and/or payer may be or include any number of different individuals, organizations, systems, devices, and the like. Payer and/or payee entities may be involved in any number of different payment transactions, and such transactions may have a variety of characteristics. For example, the payee may be a utility company that receives monthly payments from thousands of customer payees, with each payment transaction being at least partially customized to each customer (e.g., based on the utility usage of that customer over a predetermined time period, based on a set amount the customer agrees to pay each month, etc.).

While such payment transactions may be due on a regular periodic basis, payees may experience dramatic variance in the manner and timing in which the payments are received based on a variety of complex factors, including how a payment is routed through financial institutions, the time of day a payment is made, the day of the week a payment is made, the locations associated with processing the payment, the currencies involved in making the payment, holidays and other seasonal factors, and a variety of other dynamics. For example, the payee may receive a higher percentage of late payments from its customers after a holiday season when many customers have more competing bills to pay, as compared to a higher percentage of on-time payments during tax season where many customers are receiving tax refunds. Embodiments of the disclosure may be used to collect and analyze information regarding any number of different factors that could affect a payment to determine a likelihood that a payer (or group of payers) will provide a payment within a predetermined time period (e.g., on or before the payment is due).

Referring again to FIG. 2, a payee may request (205), via the payee's computing device (e.g., device 120 in FIG. 1) an electronic communication from the system (e.g., server 110 in FIG. 1). The request may include the likelihood that a particular payer or payers will provide a payment within a predetermined time period, as well as containing other information (e.g., information and incentives for altering the terms of the payment as discussed below). In some embodiments, the request may identify a payer using the payer's name, account number with the payee, or any other suitable identifier.

In some embodiments, the system may be controlled by a financial institution or other entity with whom the payer has a financial account from which the payment transaction will be payed, such as a checking or savings account, credit card account, or the like. In alternate embodiments, the system may automatically generate (255) and transmit (260) electronic communications with information (such as the likelihood of payment) about a payment transaction to the payee. The request from the payee's computing device may be provided to the system using any number of different communication methods and protocols. In one embodiment, the payee computing device submits the request via an application programming interface (API) and receives an electronic response (e.g., a JavaScript Object Notation packet).

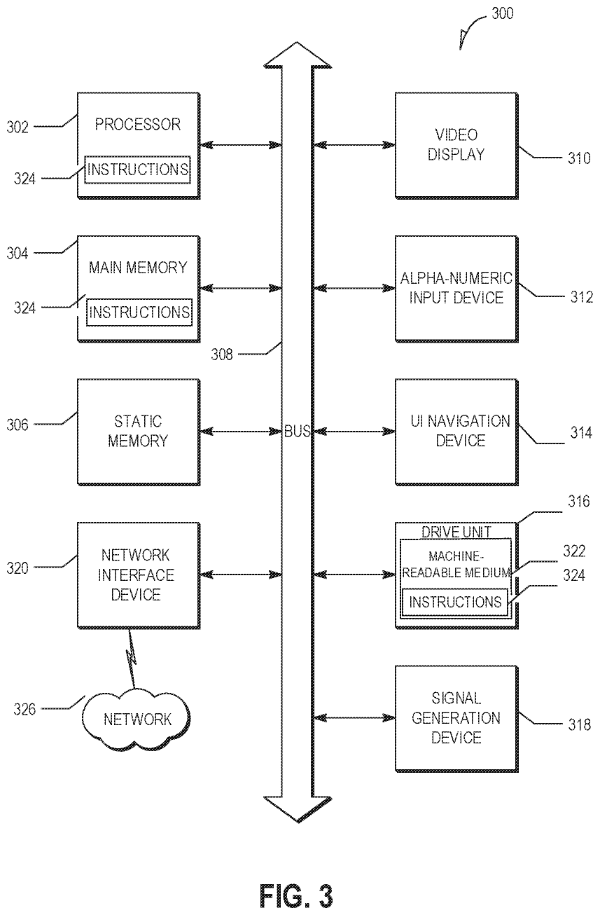

In the method 200 in FIG. 2, the system establishes a connection with a computing device of a payer (210) and requests (215) and receives (220) authorization from the payer to control the payer device to identify and transfer payment information to the system. The connection may be made in any suitable manner, such via electronic communications transmitted to and from the payer device over a network (e.g., network 140 in FIG. 1). The system may transmit and receive such electronic communications using any number and combination of different communication protocols, including those discussed above with reference to FIG. 1 and below with reference to FIG. 3. In some embodiments, the payer may pre-authorize the system to control the payer's device. In other embodiments, the payer may be prompted to authorize the system to control the payer's device each time payment information is identified and transferred, or on a periodic basis, using information displayed, and selections made by the payer, using the user interface of the payer's computing device.

The system may control the payer's computing device to perform various functions in accordance with aspects of the present disclosure. For example, the system may cause the payer's computing device to access and retrieve data stored on the payer's computing device to identify a future payment the payer is obligated to pay to a payee, as well as various information regarding the payment, such as an identifier for the payment (e.g., a transaction identifier) and the parties involved in the payment (e.g., identifiers for the payer and payee).

The system may also identify information that will (or could) affect the manner in which the payments are performed, including the length of time the payment will take using one set of factors compared to another set of factors. For example, for its analysis (235) the system may identify and consider one or more methods of payment used by the payer to satisfy the payment, routing information for the payment, the day of the week the payment originates, the time of day the payment originates, the financial institution(s) of the payer, the financial institution(s) of the payee, the amount of the payment, fees involved in processing the payment, and other factors.

The system (e.g., server 110) may control one or more client computing devices 120, 130 in any suitable manner. In some exemplary embodiments, the system may access functions exposed by the client computing device by an application programming interface to control the client computing device. The system may invoke the API functions over the network to, for example, collect the information regarding future payments the payer is obligated to pay to a payee. In other embodiments, the system may activate a software application residing on the client computing device of the payer and/or payee, and cause the software application to search for and retrieve data, and to transmit such data to the system over the network.

The system may retrieve payment history information for the payer (230) and analyze such payment history information (235) to determine the likelihood the payer will provide payment for one or more future payments by the time when such payments are due. The system may retrieve the payment history information for the payer from any desired source. For example, such information could be retrieved from the payer's computing device in conjunction with the information on the payer's future payment(s). The information could also be retrieved from a database in communication with the system (e.g., controlled by a financial institution hosting a financial account of the payer), such as database 118 in FIG. 1.

A financial institution controlling (or in communication with) the system, such as banks, credit unions, savings and loan associations, and other institutions maintaining accounts of the payer and/or payee may access accounts held at the respective financial institution(s) to process payments. The system may display a representation of the status of a financial transaction on one or more computing devices (such as the payer device 130 and payee device 120 in FIG. 1) during one or more phases of the financial transaction, in real time or near real time.

The system may analyze the payment history information for a payer (as well as other information) to determine the likelihood the payer will provide payment for the future payment by the time when the future payment is due based on a variety of factors. The likelihood the payment will be on time may be expressed in a number of ways, such as by a percentage or a level of confidence (e.g., high, medium, low) that the payer will provide payment on time. For example, the determination of the likelihood of on time payment could be based on analyzing payment procedures for one or more financial institutions that will handle the payment. Among other things, the fees an institution charges, the time required for an institution to process a payment, and other institution-specific factors may affect when or if a payment will arrive on time. Likewise, the analysis may be based on other factors, such as the method(s) of payment used by the payer to pay the future payment.

In some cases, determining the likelihood a future payment will be paid within a predetermined time by a payer may be based on payment histories and other information for other payers. For example, in some embodiments the system may analyze demographic information and/or payment history information for one or more other payers having similar characteristics to the payer for whom the likelihood of on-time payment is being determined. Such similarities may include, for example, similar income levels, residing within the same predetermined area (e.g., a zip code), and other data. In this manner, the system may use data from a larger number of sources to calculate the likelihood of on-time payment for a payer, as well as to identify trends and characteristics in payment behavior across populations of payers.

In one particular example, the system may analyze the payment procedures involved in processing a payment due in fifteen days using a particular credit card from the payer and determine that such a payment will take five days to complete. The system may also analyze the payer's payment history information and determine that 90% of the payer's payments using the particular credit card are made between seven and ten days from when the payments are due. Based on this information, the system may determine there is at least a 90% likelihood the payer will provide the future payment on time. Additionally or alternatively, the system may analyze the payment procedures for multiple payment options (e.g., a wire transfer, paper check, second credit card, etc.) and identify the variance in how long each would take to process. For example, if one payment method would take five business days to complete, and another payment option would take three business days to complete, the system may transmit a message to the payer recommending the payer utilize the faster option where the slower option would result in the payment being late.

In some embodiments, the system may be used to identify modifications to a future payment that may provide benefits for both the payer and the payee. For example, the system could identify (automatically or in response to information provided by the payee) a shortfall in the expected account balance of the payee for a particular time period. In such cases, the system could identify one or more payees with outstanding payments due and identify the cost to the payer and/or payee to accelerate the payment (240) and identify an incentive (245) to present to the payer to accelerate the payment ahead of the originally-agreed due date.

Similarly, in cases where the payee has an excess balance in its account, the system could identify the cost to a payer and/or payee to defer a payment and to identify an incentive (e.g., interest charged on the amount owed) to offer the payer to allow the payer to provide the payment at a later date in exchange for paying the higher amount. In cases where the system is identifying potential changes to the timing, amount, or other characteristics of a payment, the system may request and receive authorization (250) from a payee to offer such incentives to a payer. In some embodiments, such authorization may be sought for each payer and each instance, or for groups of payers and instances. For example, the payee may pre-authorize the system to offer incentives to accelerate payments for a limited amount of payers based on the payee's account balance falling below a predetermined threshold.

As described throughout the description above, the system may generate (255) and transmit (260) electronic communications to the computing devices of any number of different payees and payers, as well as receive electronic communications from any number of systems and devices. Such communications may include requests for authorization to perform various actions and approvals to perform such actions, as well as a variety of information. Such electronic communications may be in any desired format and utilize any desired communication protocol. Some embodiments, for example, may send and receive electronic communications such as short message service (SMS) or multimedia message service (MMS) text messages, emails, instant messages (IM), Internet relay chat (IRC), and other communications.

FIG. 3 is a block diagram illustrating exemplary components of a computing system 300 that may operate in conjunction with embodiments of the present disclosure. System 300 (in whole or in part) may be (or include) any of the computing devices 110, 120, 130 shown in FIG. 1. In this example, system 300 reads instructions 324 from a machine-readable medium (e.g., a tangible, non-transitory, machine-readable storage medium) 302 to perform a variety of functions, including any of the processes (in whole or in part) described herein.

System 300 may be connected (e.g., networked) to other machines. In a networked deployment, the system 300 may operate in the capacity of a server machine or a client machine in a server-client network environment, as well as a peer machine in a peer-to-peer (or distributed) network environment. System 300 may be (or include) a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 324, sequentially or otherwise, that specify actions to be taken by that machine. While only a single machine is illustrated in FIG. 3, the term “machine” or “system” as used herein may also include any number of different devices, systems, and/or machines that individually or jointly execute the instructions 324 to perform any one or more of the methodologies discussed herein. Additionally, alternate systems operating in conjunction with the embodiments of the present disclosure may have some, all, or multiples of the components depicted in FIG. 3.

In the example shown in FIG. 3, system 300 includes processor 302. Any processor may be used in conjunction with the embodiments of the present disclosure, such as a central processing unit (CPU), a graphics processing unit (GPU), a digital signal processor (DSP), an application specific integrated circuit (ASIC), a radio-frequency integrated circuit (RFIC), or any suitable combination thereof. System 300 further includes a main memory 304 and a static memory 306, which are configured to communicate with each other via a bus 308.

The system 300 further includes a user interface that may include a variety of components, including one or more output devices such as a graphics display 310 (e.g., a plasma display panel (PDP), a light emitting diode (LED) display, a liquid crystal display (LCD), a projector, or a cathode ray tube (CRT)). The user interface of the system 300 may also include any number of input devices and other components, including an alphanumeric input device 312 (e.g., a keyboard), a cursor control device 314 (e.g., a mouse, a touchpad, a trackball, a joystick, a motion sensor, or other pointing instrument), a storage unit 316, a signal generation device 318 (e.g., a speaker), and a network interface device 320.

The storage unit 316 includes a machine-readable medium 322 on which is stored the instructions 324 (e.g., software) embodying any one or more of the methodologies or functions described herein. The instructions 324 may also reside, completely or at least partially, within the main memory 304, within the processor 302 (e.g., within the processor's cache memory), or both, during execution thereof by the system 300. Accordingly, the main memory 304 and the processor 302 may be considered as machine-readable media. The instructions 324 may be transmitted or received over a network 326 via the network interface device 320.

As used herein, the term “memory” may refer to any machine-readable medium able to store data temporarily or permanently, including random-access memory (RAM), read-only memory (ROM), buffer memory, flash memory, and/or cache memory. While the machine-readable medium 322 is shown in this example as a single medium, the term “machine-readable medium” may include a single medium or multiple media (e.g., a centralized or distributed database, or associated caches and servers) able to store instructions 324. The term “machine-readable medium” may also include any medium, or combination of multiple media, that is capable of storing instructions (e.g., software) 324 for execution by a machine. Accordingly, a “machine-readable medium” refers to a single storage apparatus or device, as well as “cloud-based” storage systems or storage networks that include multiple storage apparatus or devices.

The term “machine-readable medium” may also include one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Although an overview of the inventive subject matter has been described with reference to specific exemplary embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

1. A system comprising:
a processor; and
memory coupled to the processor and storing instructions that, when executed by the processor, cause the system to perform operations comprising:
establishing a connection, over a network, with a client computing device of a payer;
receiving, over the network from the client computing device of the payer, information regarding a future payment that the payer is obligated to pay to a payee, wherein the system controls the client computing device of the payer over a first application programming interface to identify and transfer payment information to the system;
retrieving, from a database in communication with the system, payment history information for the payer;
calculating a likelihood that the payer will provide payment for the future payment by a time that the future payment is due, wherein the calculating includes:
identifying demographic information for the payer;
identifying a plurality of users having matching demographic information; and
using a predictive model to calculate the likelihood that the payer will provide payment for the future payment by the time that the future payment is due based on payment histories for the identified plurality of users; and
prior to the time that the future payment is due:
generating a first electronic communication, the first electronic communication containing the calculated likelihood that the payer will provide payment for the future payment by the time that the future payment is due;
transmitting the first electronic communication, over the network, to a client computing device of the payee;
identifying an incentive to offer the payer in exchange for accelerating the payment;
transmitting a second electronic communication, over the network, to the client computing device of the payee, the second electronic communication requesting authorization to offer the incentive for accelerating the payment to the payer; and
in response to receiving authorization to offer the incentive for accelerating the payment, transmitting a third electronic communication, over the network, to the client computing device of the payer, the third electronic communication containing an offer of the incentive.

2. The system of claim 1, the operations further comprising:
receiving, over the network, a request from the client computing device of the payee for the first electronic communication, the request including identification information for the payer.

3. The system of claim 2, wherein the request from the client computing device of the payee for the first electronic communication is received via a second application programming interface.

4. The system of claim 1, the operations further comprising:
transmitting, over the network, a fourth electronic communication, the fourth electronic communication containing a request to the client computing device of the payer to control the client computing device of the payer to identify and transfer payment information to the system; and
receiving, over the network, a fifth electronic communication, the fifth electronic communication containing authorization from the payer to control the client computing device of the payer to identify and transfer payment information to the system,
wherein the system controls the client computing device of the payer over the first application programming interface to identify and transfer payment information to the system in response to receiving the fifth electronic communication.

5-6. (canceled)

7. The system of claim 1, wherein the calculating of the likelihood that the payer will provide payment for the future payment by the time that the future payment is due is further based on payment procedures for one or more financial institutions that will handle payment of the future payment by the payer.

8. The system of claim 1, wherein the calculating of the likelihood that the payer will provide payment for the future payment by the time that the future payment is due is further based on a method of payment that will be used by the payer to pay the future payment.

9. (canceled)

10. A computer-implemented method comprising:
establishing a connection, by a computer system over a network, with a client computing device of a payer;
receiving, by the computer system over the network from the client computing device of the payer, information regarding a future payment that the payer is obligated to pay to a payee, wherein the computer system controls the client computing device of the payer over a first application programming interface to identify and transfer payment information to the computer system;
retrieving, by the computer system from a database in communication with the computer system, payment history information for the payer;
calculating, by the computer system, a likelihood that the payer will provide payment for the future payment by a time that the future payment is due, wherein the calculating includes:
identifying demographic information for the payer;
identifying a plurality of users having matching demographic information; and
using a predictive model to calculate the likelihood that the paver will provide payment for the future payment by the time that the future payment is due based on payment histories for the identified plurality of users; and
prior to the time that the future payment is due:
generating, by the computer system, a first electronic communication, the first electronic communication containing the calculated likelihood that the payer will provide payment for the future payment by the time that the future payment is due;
transmitting the first electronic communication, by the computer system over the network, to a client computing device of the payee;
identifying, by the computer system, an incentive to offer the payer in exchange for accelerating the payment;
transmitting, by the computer system over the network, a second electronic communication to the client computing device of the payee, the second electronic communication requesting authorization to offer the incentive for accelerating the payment to the payer; and
in response to receiving authorization to offer the incentive for accelerating the payment, transmitting, by the computer system over the network, a third electronic communication to the client computing device of the payer, the third electronic communication containing an offer of the incentive.

11. The method of claim 10, further comprising:
receiving, by the computer system over the network, a request from the client computing device of the payee for the first electronic communication, the request including identification information for the payer.

12. The method of claim 11, wherein the request from the client computing device of the payee for the first electronic communication is received via a second application programming interface.

13. The method of claim 10, further comprising:
transmitting, by the computer system over the network, a fourth electronic communication, the fourth electronic communication containing a request to the client computing device of the payer to control the client computing device of the payer to identify and transfer payment information to the computer system; and
receiving, by the computer system over the network, a fifth electronic communication, the fifth electronic communication containing authorization from the payer to control the client computing device of the payer to identify and transfer payment information to the computer system,
wherein the computer system controls the client computing device of the payer over the first application programming interface to identify and transfer payment information to the computer system in response to receiving the fifth electronic communication.

14-15. (canceled)

16. The method of claim 10, wherein the calculating of the likelihood that the payer will provide payment for the future payment by the time that the future payment is due is further based on payment procedures for one or more financial institutions that will handle payment of the future payment by the payer.

17. The method of claim 10, wherein the calculating of the likelihood that the payer will provide payment for the future payment by the time that the future payment is due is further based on a method of payment that will be used by the payer to pay the future payment.

18. (canceled)

19. A non-transitory computer-readable medium storing instructions that, when executed by a computer system, cause the computer system to perform operations comprising:
establishing a connection, over a network, with a client computing device of a payer;
receiving, over the network from the client computing device of the payer, information regarding a future payment that the payer is obligated to pay to a payee, wherein the computer system controls the client computing device of the payer over a first application programming interface to identify and transfer payment information to the computer system;
retrieving, from a database in communication with the computer system, payment history information for the payer;
calculating, by the computer system, a likelihood that the payer will provide payment for the future payment by a time that the future payment is due, wherein the calculating includes:
identifying demographic information for the payer;
identifying a plurality of users having matching demographic information; and
using a predictive model to calculate the likelihood that the paver will provide payment for the future payment by the time that the future payment is due based on payment histories for the identified plurality of users; and
prior to the time that the future payment is due:
generating a first electronic communication, the first electronic communication containing the calculated likelihood that the payer will provide payment for the future payment by the time that the future payment is due;
transmitting the first electronic communication, over the network, to a client computing device of the payee;
identifying an incentive to offer the payer in exchange for accelerating the payment;
transmitting a second electronic communication, over the network, to the client computing device of the payee, the second electronic communication requesting authorization to offer the incentive for accelerating the payment to the payer; and
in response to receiving authorization to offer the incentive for accelerating the payment, transmitting a third electronic communication, over the network, to the client computing device of the payer, the third electronic communication containing an offer of the incentive.

20. (canceled)

21. The non-transitory computer-readable medium of claim 19, the operations further comprising:
transmitting, over the network, a fourth electronic communication, the fourth electronic communication containing a request to the client computing device of the payer to control the client computing device of the payer to identify and transfer payment information to the computer system; and
receiving, over the network, a fifth electronic communication, the fifth electronic communication containing authorization from the payer to control the client computing device of the payer to identify and transfer payment information to the computer system,
wherein the computer system controls the client computing device of the payer over the first application programming interface to identify and transfer payment information to the computer system in response to receiving the fifth electronic communication.
